(19) United States
(12) Patent Application Publication
(10) Pub. No.: US 2026/0099394 A1
(43) Pub. Date: Apr. 9, 2026

(54) Function as a Service Dynamic Event Propagation

(71) Applicant: Dell Products L.P., Round Rock, TX (US)

(72) Inventors: Boris Shpilyuck, Ashdod (IL); Yair Yotam, Lehavim (IL); Igor Dubrovsky, Beer-Sheva (IL)

(21) Appl. No.: 18/909,911

(22) Filed: Oct. 8, 2024

(51) Int. Cl. G06F 9/54

(52) U.S. Cl. CPC G06F 9/546; G06F 9/542

(57) ABSTRACT

A system can maintain a function-as-a-service architecture that comprises a group of executable serverless functions, a group of message consumers, and a group of message brokers, wherein respective message brokers of the group of message brokers are configured to transmit respective messages to respective message consumers of the group of message consumers, and wherein the respective message consumers are configured to transmit the respective messages to respective functions of the group of executable serverless functions. The system can determine respective utilization metrics of the respective message consumers. The system can determine that a utilization metric of the respective utilization metrics satisfies a misutilization criterion. The system can adjust which ones of the message brokers communicate with which ones of the message consumers based on the utilization metric being determined to satisfy the misutilization criterion.

### BACKGROUND

A function as a service (FaaS) can comprise a form of serverless computing from a cloud computing service, where a user can execute application functionalities without having built the infrastructure associated with developing a full application. A FaaS can be executed on demand, which can avoid a situation where it is always running and consuming computing resources.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can maintain a function-as-a-service architecture that comprises a group of executable serverless functions, a group of message consumers, and a group of message brokers, wherein respective message brokers of the group of message brokers are configured to transmit respective messages to respective message consumers of the group of message consumers, and wherein the respective message consumers are configured to transmit the respective messages to respective functions of the group of executable serverless functions. The system can determine respective utilization metrics of the respective message consumers. The system can determine that a utilization metric of the respective utilization metrics satisfies a misutilization criterion. The system can adjust which ones of the message brokers communicate with which ones of the message consumers based on the utilization metric being determined to satisfy the misutilization criterion.

An example method can comprise determining, by a system comprising at least one processor, respective utilization metrics of respective message consumers of a group of message consumers of a function-as-a-service architecture, the function-as-a-service architecture comprising a group of executable serverless functions, the group of message consumers, and a group of message brokers. The method can further comprise determining, by the system, that a utilization metric of the respective utilization metrics satisfies a misutilization criterion. The method can further comprise adjusting, by the system, which ones of the message brokers communicate with which ones of the message consumers based on the utilization metric being determined to satisfy the misutilization criterion.

An example non-transitory computer-readable medium can comprise instructions that, in response to execution, cause a system comprising a processor to perform operations. These operations can comprise determinizing respective utilization metrics of respective message consumers that communicate with respective message brokers in a function-as-a-service platform. These operations can further comprise determining that a utilization metric of the respective utilization metrics satisfies a misutilization criterion. These operations can further comprise adjusting which of the message brokers communicate with which of the message consumers based on the utilization metric satisfying the misutilization criterion.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate FaaS dynamic event propagation, in accordance with an embodiment of this disclosure;

FIG. 2 illustrates another example system architecture that can facilitate FaaS dynamic event propagation, in accordance with an embodiment of this disclosure;

FIG. 3 illustrates an example of an overutilized consumer, and that can facilitate FaaS dynamic event propagation, in accordance with an embodiment of this disclosure;

FIG. 4 illustrates another example of an overutilized consumer, and that can facilitate FaaS dynamic event propagation, in accordance with an embodiment of this disclosure;

FIG. 5 illustrates example pseudocode for handling an overutilized consumer, and that can facilitate FaaS dynamic event propagation, in accordance with an embodiment of this disclosure;

FIG. 6 illustrates an example of an underutilized consumer, and that can facilitate FaaS dynamic event propagation, in accordance with an embodiment of this disclosure;

FIG. 7 illustrates another example of an underutilized consumer, and that can facilitate FaaS dynamic event propagation, in accordance with an embodiment of this disclosure;

FIG. 8 illustrates example pseudocode for handling an underutilized consumer, and that can facilitate FaaS dynamic event propagation, in accordance with an embodiment of this disclosure;

FIG. 9 illustrates an example of unbalanced consumption, and that can facilitate FaaS dynamic event propagation, in accordance with an embodiment of this disclosure;

FIG. 10 illustrates another example of unbalanced consumption, and that can facilitate FaaS dynamic event propagation, in accordance with an embodiment of this disclosure;

FIG. 11 illustrates example pseudocode for handling unbalanced consumption, and that can facilitate FaaS dynamic event propagation, in accordance with an embodiment of this disclosure;

FIG. 12 illustrates an example process flow that can facilitate FaaS dynamic event propagation, in accordance with an embodiment of this disclosure;

FIG. 13 illustrates another example process flow that can facilitate FaaS dynamic event propagation, in accordance with an embodiment of this disclosure;

FIG. 14 illustrates another example process flow that can facilitate FaaS dynamic event propagation, in accordance with an embodiment of this disclosure; and

FIG. 15 illustrates an example block diagram of a computer operable to execute an embodiment of this disclosure.

### DETAILED DESCRIPTION

### Overview

A function as a Service or (FaaS) can comprise a service allocated by a cloud platform to achieve a “serverless” execution model. In this form of execution, the platform can be leveraged to control aspects of execution layers, allowing a developer to focus on business logic.

### A FaaS Platform can Generally Control Two Aspects of Execution:

1. Actions—which function to trigger (e.g., via hypertext transport protocol (HTTP) request, sys call, etc.)
2. Events—what can cause a function to trigger. This can be achieved by incorporating a message broker into the system and allowing the platform to encapsulate the logic behind it.

Developer focus on business logic can be achieved by creating an abstraction layer that handles communication with event sources, allowing the function creator to define only the event name(s) that cause the function to trigger.

For example, a function can register to “order-changes” events by declaring the event name as part of creation configuration. In turn, the platform can register to a topic/subject/queue-depending on the underlying message broker used by the platform (might even be several of which).

From a platform perspective, message consumption and propagation can be done in multiple ways, such as:
1. Monolithic approach—create a single server that registers (subscribes) to required message queues; scale up if needed.
2. Multiple instance approach—each instance registers to one or more message queues; scales out when required.

A problem can exist where FaaS platform resources to propagate events to appropriate function can be difficult and subject to several challenges.

In a monolithic approach, it can be hard to support demand as scale increases, and it might not be practical at all for compute/memory intensive deployments. Moreover, this approach can generate a constant cost even if not fully utilized.

In a multiple instance approach, assigning subscribers to instances can lead to multiple problems:
1. Underutilized instances—some instances can propagate messages rarely, causing excess consumption of resources while idle.
2. Overutilized instances—some instances can subscribe to multiple message queues, which in turn can maximize the consumption rate, causing an application to be less responsive.
3. Starvation—some instances can subscribe to high volume message queues together with low volume message queues, which in turn can create unbalanced consumption and lead to other functions' starvation.

The present techniques can address these problems with prior approaches by collecting information of the message consumer instances, performing analysis of several parameters, such as message volume, throughput, resources utilization (central processing unit (CPU) and memory), and performing dynamic redistribution of the message consumers to prevent over/under utilization and starvation of function event/message propagation.

In cases when not many events are consumed at a given period, the system can have consumers that are not utilized, and this can result in a waste of money and resources. It can be that scaling down to fewer consumers is not trivial where a constant connection with a message broker is maintained. There can be a need to make an informed decision on where to assign the existing consumer connections.

When high volume of events are propagated by the system at a given period, certain message consumer instances can use a maximum number of allocated resources, and as a result, can require scaling out to more instances. However, it can be that adding more consumer instances is not trivial, since splitting the connection between several instances can cause an unbalance, so not solve the problem.

In some cases, events from specific business logic may have a higher velocity, which in turn can “starve” functions with a lower velocity (and higher priority). This can increase latency in some parts of the application.

The present techniques can be implemented to reduce compute resources by merging one or more FaaS message consumer according to provided criteria. Additionally, the present techniques can be implemented to split high load consumers to optimal instances while maintaining a balance between message consumption and delivery and avoiding a starvation state to message channels.

The present techniques can be implemented to aggregate underutilized message consumers via a use of configurable parameters and statistics to determine optimal merge strategy of underutilized message consumers.

The present techniques can be implemented to split overutilized message consumers via a use of configurable parameters and statistics and perform an optimal split of message consumer instances.

The present techniques can be implemented to avoid starvation of FaaS events by rebalancing message channels between idle/inactive consumers.

### Example Architectures, Tables, and Flows

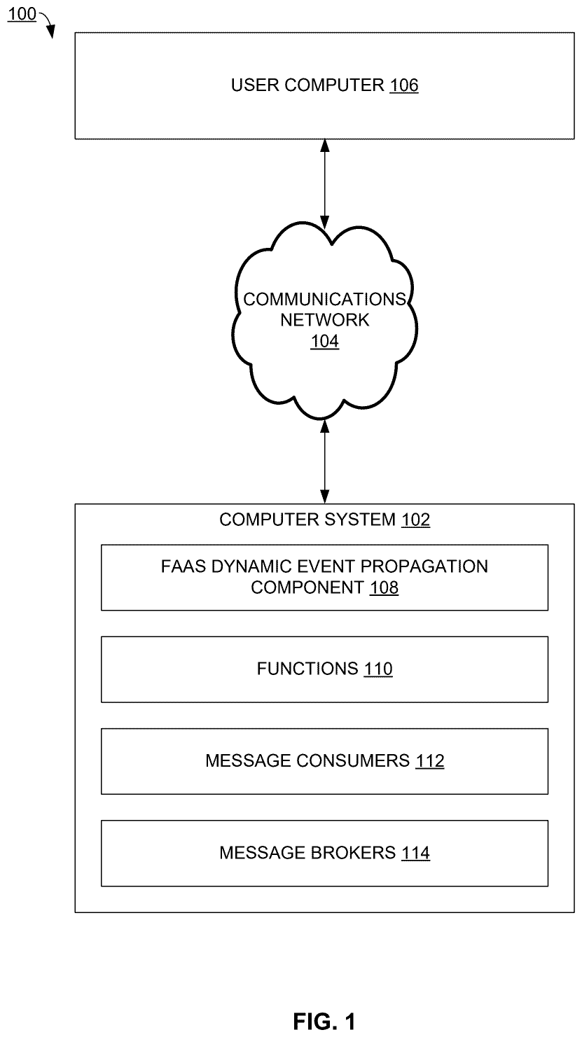

FIG. 1 illustrates an example system architecture 100 that can facilitate FaaS dynamic event propagation, in accordance with an embodiment of this disclosure.

System architecture 100 comprises computer system 102, communications network 104, and user computer 106. In turn, computer system 102 comprises FaaS dynamic event propagation component 108, functions 110, message consumers 112, and message brokers 114.

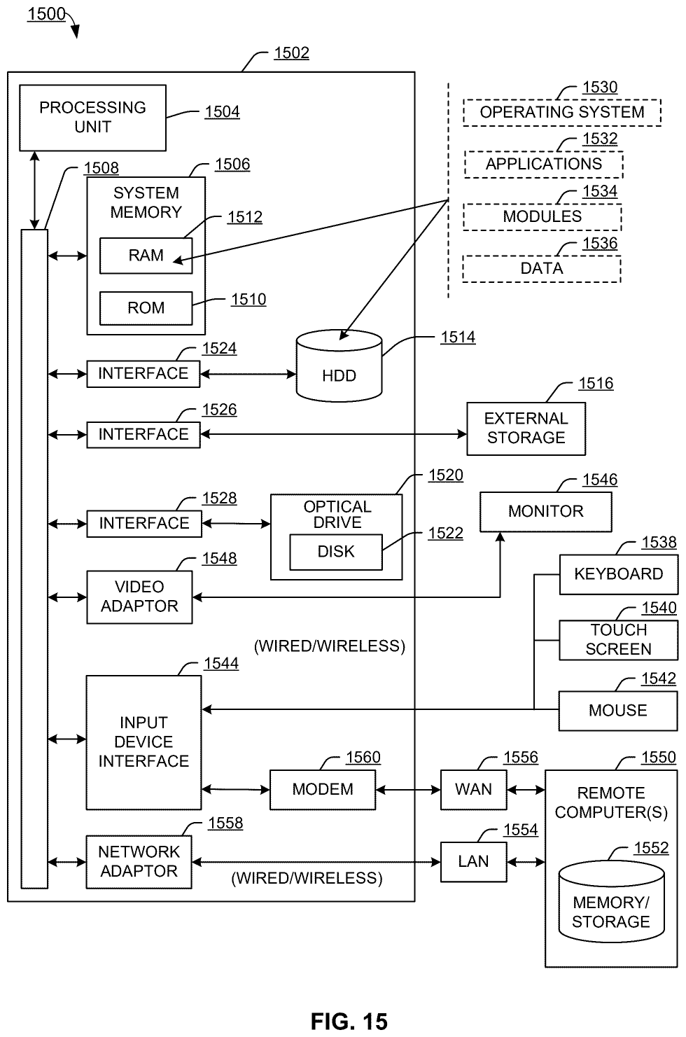

Each of computer system 102 and/or user computer 106 can be implemented with part(s) of computing environment 1500 of FIG. 15. Communications network 104 can comprise a computer communications network, such as the Internet, or an isolated private computer communications network.

Computer system 102 can comprise a cloud computing platform that provides computer services to user computer 106. User computer 106 can make a request to computer system 102 via communications network 104, and serving that request can comprise executing one or more functions of functions 110.

It can be that functions of functions 110 are not always executing, but are executed on demand. So, a message can be generated for a function (e.g., from a message broker of message brokers 114) and that message is held by a message consumer of message consumers 112 until such a time that the function is executing and able to receive the message.

This architecture—of functions, message brokers, and message consumers—can lead to scenarios where there are too many or too few message consumers, or that the connections between functions, message brokers, and message consumers can be improved upon. FaaS dynamic event propagation component 108 can analyze the messages being transmitted, and the arrangement of functions, message brokers, and message consumers, and alter the arrangement to improve functioning of message transfer.

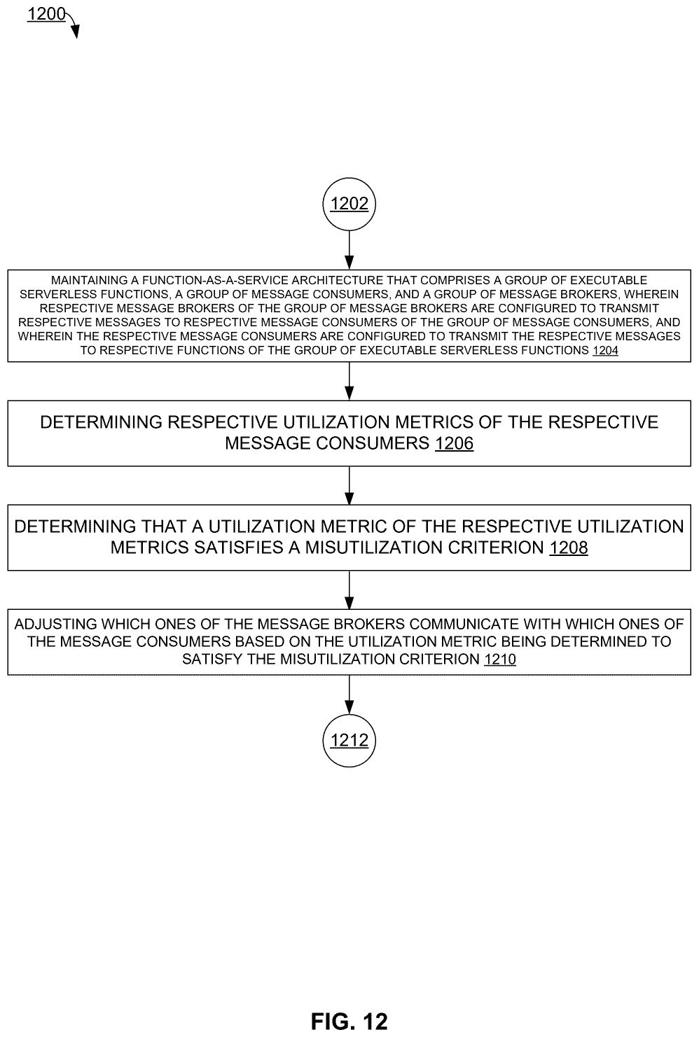

In some examples, FaaS dynamic event propagation component 108 can implement part(s) of the process flows of FIGS. 12-14 to facilitate FaaS dynamic event propagation.

It can be appreciated that system architecture 100 is one example system architecture for FaaS dynamic event propagation, and that there can be other system architectures that facilitate FaaS dynamic event propagation.

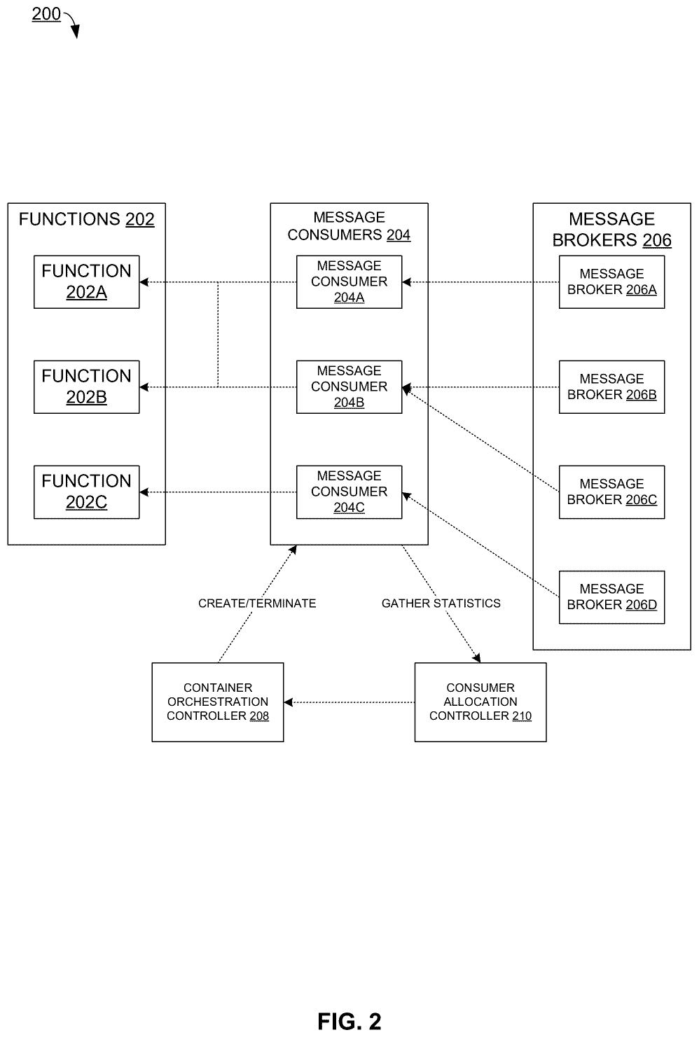

FIG. 2 illustrates another example system architecture that can facilitate FaaS dynamic event propagation, in accordance with an embodiment of this disclosure. In some examples, part(s) of system architecture 200 can be implemented by part(s) of system architecture 100 of FIG. 1 to facilitate FaaS dynamic event propagation.

System architecture 200 comprises functions 202 (comprising function 202A, function 202B, and function 202C), message consumers 204 (comprising message consumer 204A, message consumer 204B, and message consumer 204C), message brokers 206 (comprising message broker 206A, message broker 206B, message broker 206C, and message broker 206D), container orchestration controller 208, and consumer allocation controller 210.

An example system according to the present techniques can perform ongoing statistics collection of event propagation from a message broker, analyze these statistics and decide between the following:
1. Keep a current state;
2. Increase message consumers and redistribute message queues;
3. Reduce message consumers and redistribute message queues; and
4. Reallocate message queues to different consumers.

### This Example System Architecture Comprises:

Message brokers 206: Allows the application to communicate and exchange information asynchronously.
Message Consumers 204: Instances used by a FaaS platform to consume messages and propagate these messages to the subscribed function(s).
Container orchestration controller 208: Responsible for controlling container creation and termination as part of containerized application orchestrators.
Consumer allocation controller 210: This component can collect message consumption statistics from message consumer instances, analyze the information, and change message consumer scale and message queue allocation accordingly.

### Consumer Allocation Controller 210 can Collect the Following Parameters:

1. The average CPU utilization percentage can be referred to as C.
2. The average memory utilization percentage can be referred to as M.
3. The average throughput (kilobytes/second (KB/sec) of a message queue can be referred to as TQ(i).
4. The average unread queue size of queue i can be referred to as U (i).
   i can vary between 1 . . . . N, where N represents the total number of queues in the system.

In the following example scenarios, the behavior of the allocation component is described for (1) overutilization, (2) underutilization, and (3) starvation.

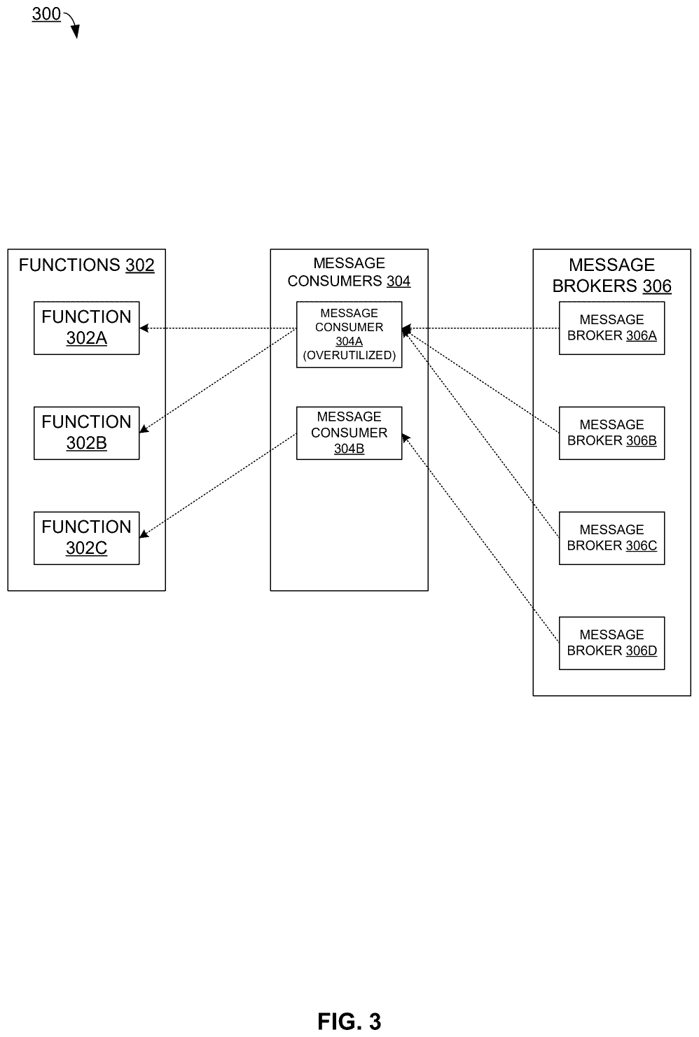

FIG. 3 illustrates an example 300 of an overutilized consumer, and that can facilitate FaaS dynamic event propagation, in accordance with an embodiment of this disclosure. In some examples, part(s) of example 300 can be implemented by part(s) of system architecture 100 of FIG. 1 to facilitate FaaS dynamic event propagation.

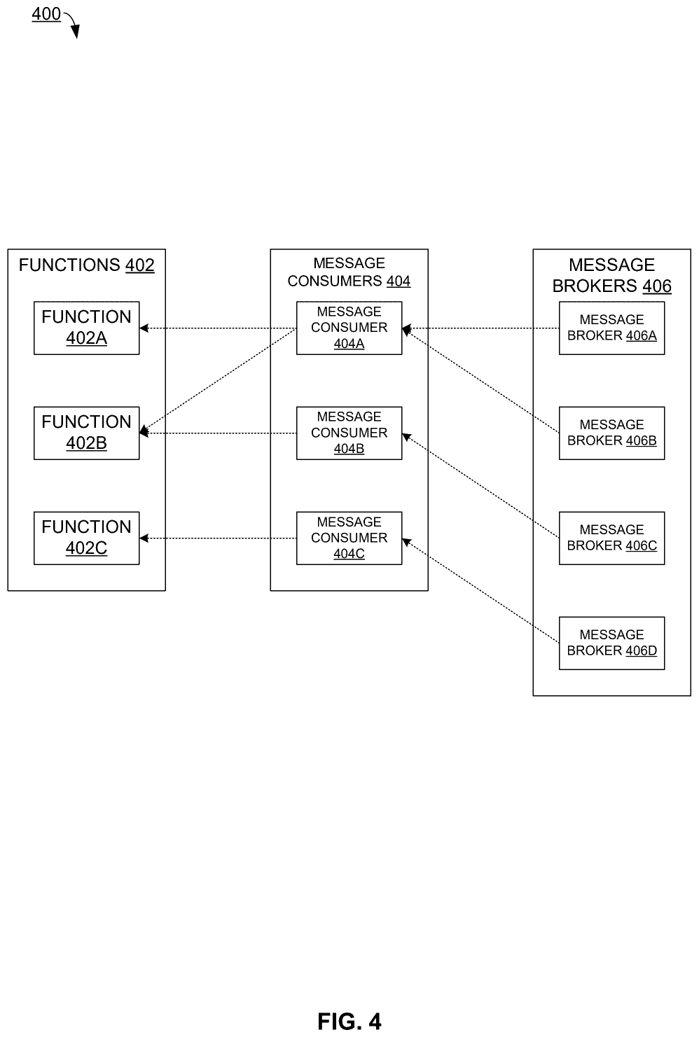

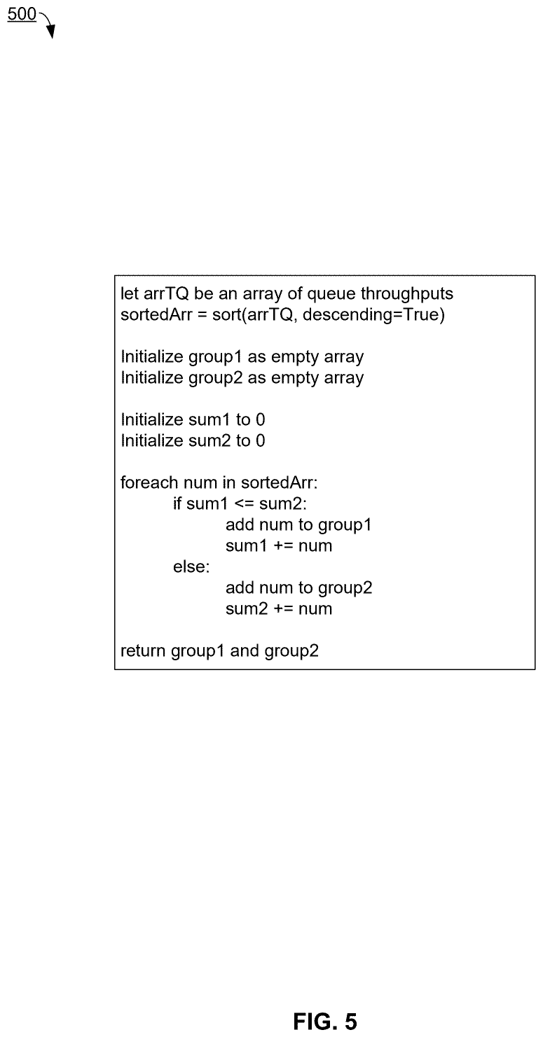

The examples of FIG. 3 and FIG. 4 can combine to show an overutilized consumer example (FIG. 3) and remediating that overutilized consumer example (FIG. 4). FIG. 5 can illustrate corresponding pseudocode to effectuate this.

Example 300 comprises function 302A, function 302B, function 302C, message consumer 304A, message consumer 304B, message broker 306A, message broker 306B, message broker 306C, and message broker 306D.

An overutilization example is as follows. In cases where a message consumer consumes a certain number of messages from different queues, it can become overutilized. This state can be defined as follows for a specific message consumer:
1. Check if C is greater than MAX_C %. MAX_C can be a predefined system parameter.
2. Check if M is greater than MAX_M %. MAX_M can be a predefined system parameter.
3. There are at least two message queues attached to the consumer.

Configurable parameter T can be defined as the number of milliseconds used to determine the average parameters.

When (#1 OR #2) AND #3 of the above conditions are met, the number of message consumers can be increased, and one or more queues can be assigned to the new instance.

FIG. 4 illustrates another example 400 of an overutilized consumer, and that can facilitate FaaS dynamic event propagation, in accordance with an embodiment of this disclosure. In some examples, part(s) of example 400 can be implemented by part(s) of system architecture 100 of FIG. 1 to facilitate FaaS dynamic event propagation.

Example 400 comprises function 402A, function 402B, function 402C, message consumer 404A, message consumer 404B, message consumer 404C, message broker 406A, message broker 406B, message broker 406C, and message broker 406D.

In this example, an overutilized consumer splits the message channels to another consumer to reduce the load.

In some examples, a goal can be to balance the two groups and have the sum of the groups be as close as possible.

For example, assuming the following group of queue throughput:

$$\{ TQ ( 1 ) = 1 , TQ ( 2 ) = 4 , TQ ( 3 ) = 7 , TQ ( 4 ) = 10 \}$$

A possible optimal group split for this use case can be:

$$GroupA \{ TQ ( 1 ) = 1 , TQ ( 4 ) = 10 \}$$

$${\sum }_{i = 1}^{N} GroupA ( i ) = 11$$

$$GroupB \{ TQ ( 2 ) = 4 , TQ ( 3 ) = 7 \}$$

$${\sum }_{i = 1}^{N} GroupB ( i ) = 11$$

Where the examples herein describe an “optimal” implementation (or use other superlatives), it can be appreciated that there can be examples of the present techniques that facilitate a suitable implementation.

FIG. 5 illustrates example pseudocode 500 for handling an overutilized consumer, and that can facilitate FaaS dynamic event propagation, in accordance with an embodiment of this disclosure. In some examples, part(s) of pseudocode 500 can be implemented by part(s) of system architecture 100 of FIG. 1 to facilitate FaaS dynamic event propagation.

The following pseudocode can be implemented to split the group of queues between the new consumer instances:

```
let arrTQ be an array of queue throughputs sortedArr =
sort(arrTQ, descending=True)
Initialize group1 as empty array
Initialize group2 as empty array
Initialize sum1 to 0
Initialize sum2 to 0
foreach num in sortedArr:
  if sum1 <= sum2:
    add num to group1
    sum1 += num
else:
    add num to group2
  sum2 += num
return group1 and group2
```

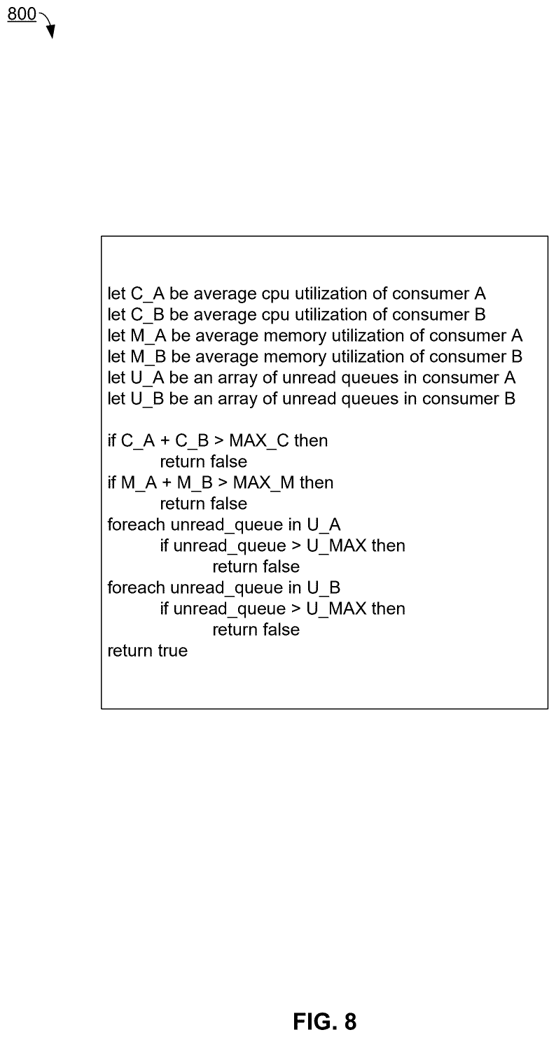

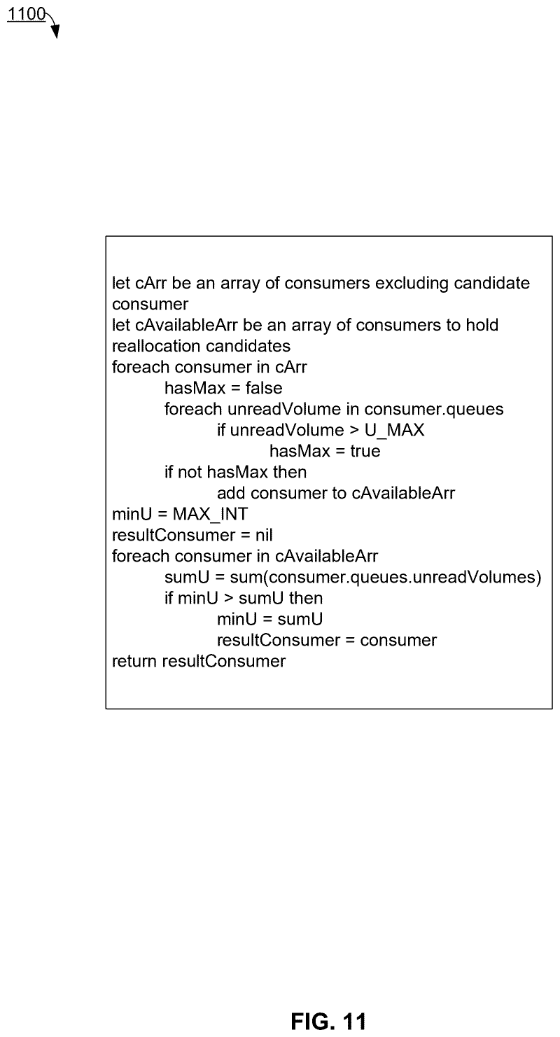

It can be appreciated that pseudocode 500 is one example implementation of how to address an overutilized consumer, and there can be other approaches to achieve the same, or a similar, result. Pseudocode 800 of FIG. 8 and pseudocode 1100 of FIG. 11 are similar examples.

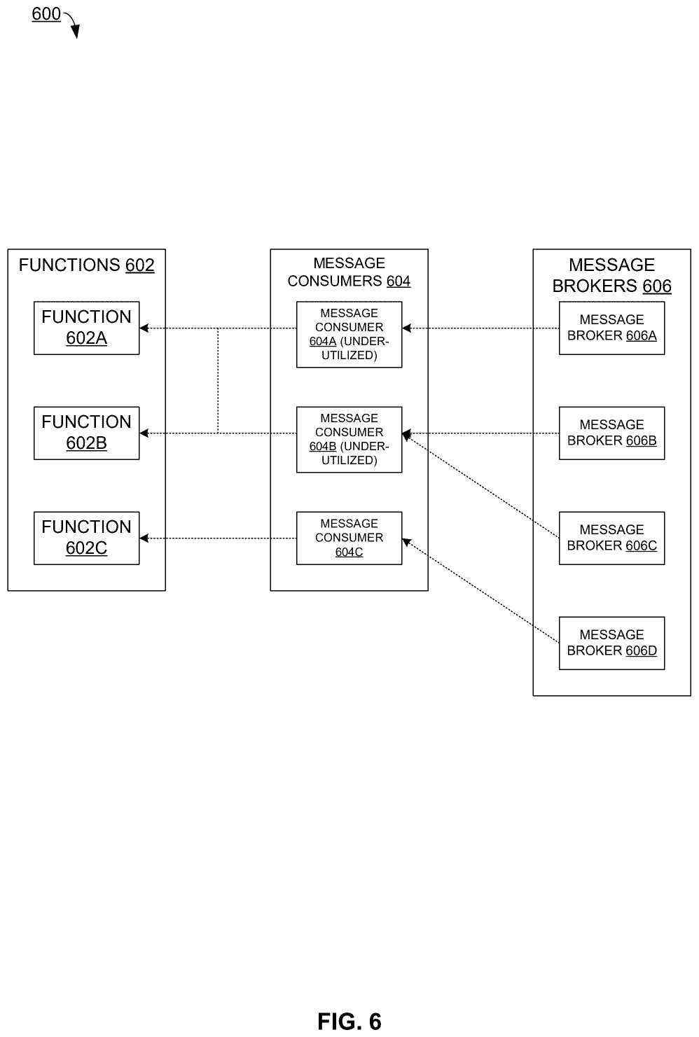

FIG. 6 illustrates an example 600 of an underutilized consumer, and that can facilitate FaaS dynamic event propagation, in accordance with an embodiment of this disclosure. In some examples, part(s) of example 600 can be implemented by part(s) of system architecture 100 of FIG. 1 to facilitate FaaS dynamic event propagation.

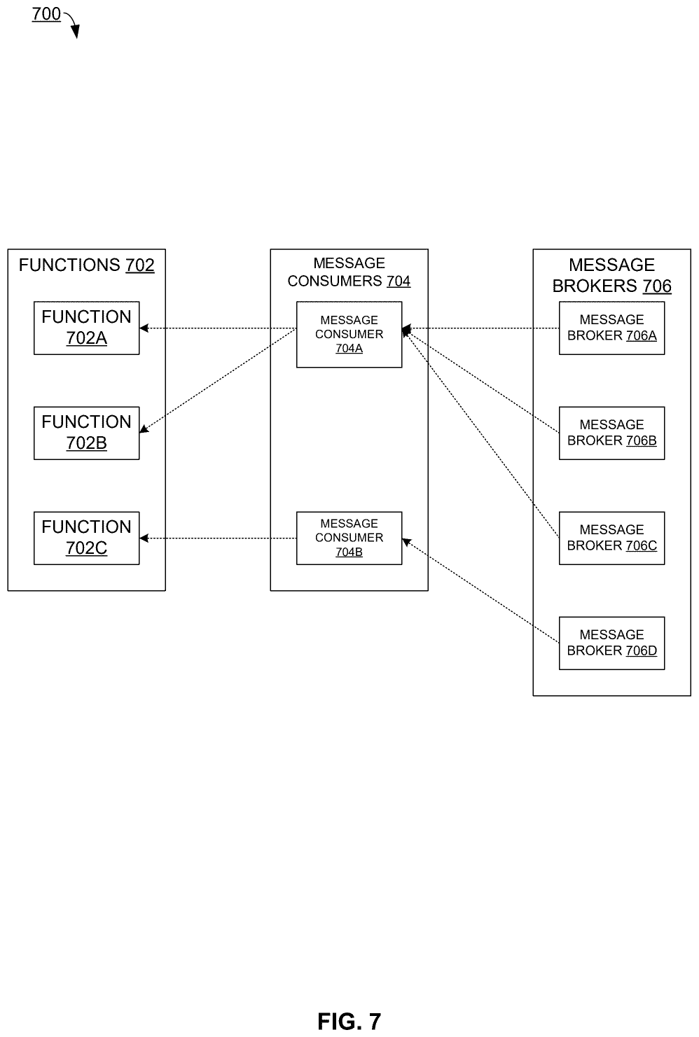

The examples of FIG. 6 and FIG. 7 can combine to show an underutilized consumer example (FIG. 6) and remediating that underutilized consumer example (FIG. 7). FIG. 8 can illustrate corresponding pseudocode to effectuate this.

Example 600 comprises function 602A, function 602B, function 602C, message consumer 604A, message consumer 604B, message consumer 604C, message broker 606A, message broker 606B, message broker 606C, and message broker 606D.

An underutilized message consumer example is as follows. When at least two message consumers are idle or underutilized, these instances can be merged to a single consumer in order to reduce resource consumption.

Two consumers can be a merge candidate where the following conditions are met for both:
1. Check if C is less than C_MIN %. C_MIN can be a predefined system parameter.
2. Check if M is greater than M_MIN %. M_MIN can be a predefined system parameter.

The configurable parameter T can be defined as the number of milliseconds used to determine the average parameters.

When #1 and #2 of the above conditions are met for at least two consumers, a check can be made of whether merge of two or more consumers can possible according to a merge strategy.

FIG. 7 illustrates another example 700 of an underutilized consumer, and that can facilitate FaaS dynamic event propagation, in accordance with an embodiment of this disclosure. In some examples, part(s) of example 700 can be implemented by part(s) of system architecture 100 of FIG. 1 to facilitate FaaS dynamic event propagation.

Example 700 comprises function 702A, function 702B, function 702C, message consumer 704A, message consumer 704B, message broker 706A, message broker 706B, message broker 706C, and message broker 706D.

Relative to FIG. 6, in FIG. 7, two message consumers have been combined to address an underutilized consumer scenario.

FIG. 8 illustrates example pseudocode for handling an underutilized consumer, and that can facilitate FaaS dynamic event propagation, in accordance with an embodiment of this disclosure. In some examples, part(s) of pseudocode 800 can be implemented by part(s) of system architecture 100 of FIG. 1 to facilitate FaaS dynamic event propagation.

In some examples, all merge candidates can be iterated over, and the following pseudocode can be implemented as merge strategy of underutilized consumers:

```
let C_A be average CPU utilization of consumer A
let C_B be average CPU utilization of consumer B
let M_A be average memory utilization of consumer A
let M_B be average memory utilization of consumer B
let U_A be an array of unread queues in consumer A
let U_B be an array of unread queues in consumer B
if C_A + C_B > MAX_C then
  return false
if M_A + M_B > MAX_M then
  return false
foreach unread_queue in U_A
  if unread_queue > U_MAX then
    return false
foreach unread_queue in U_B
  if unread_queue > U_MAX then
    return false
return true
```

That is, it can be that Two Candidates are Merged where the Following is Met:
1. The average CPU utilization after merging the consumers does not exceed maximum utilization parameter.
2. The average memory utilization after merging the consumers does not exceed maximum utilization parameter.
3. In each consumer, no unread message amount exceeds the maximum parameter.

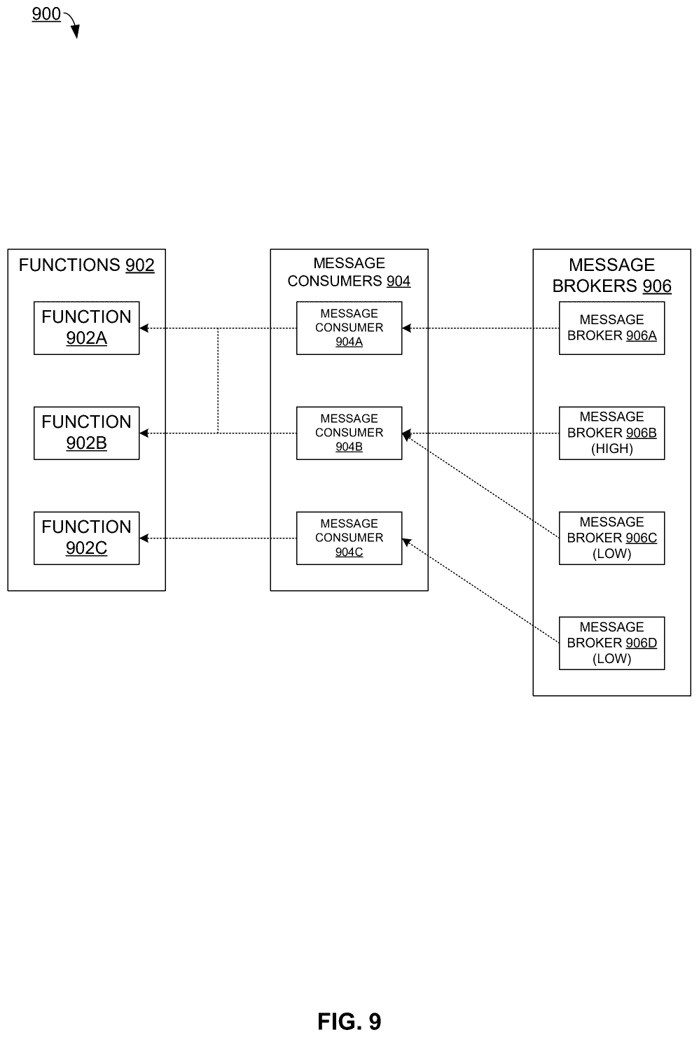

FIG. 9 illustrates an example 900 of unbalanced consumption, and that can facilitate FaaS dynamic event propagation, in accordance with an embodiment of this disclosure. In some examples, part(s) of example 900 can be implemented by part(s) of system architecture 100 of FIG. 1 to facilitate FaaS dynamic event propagation.

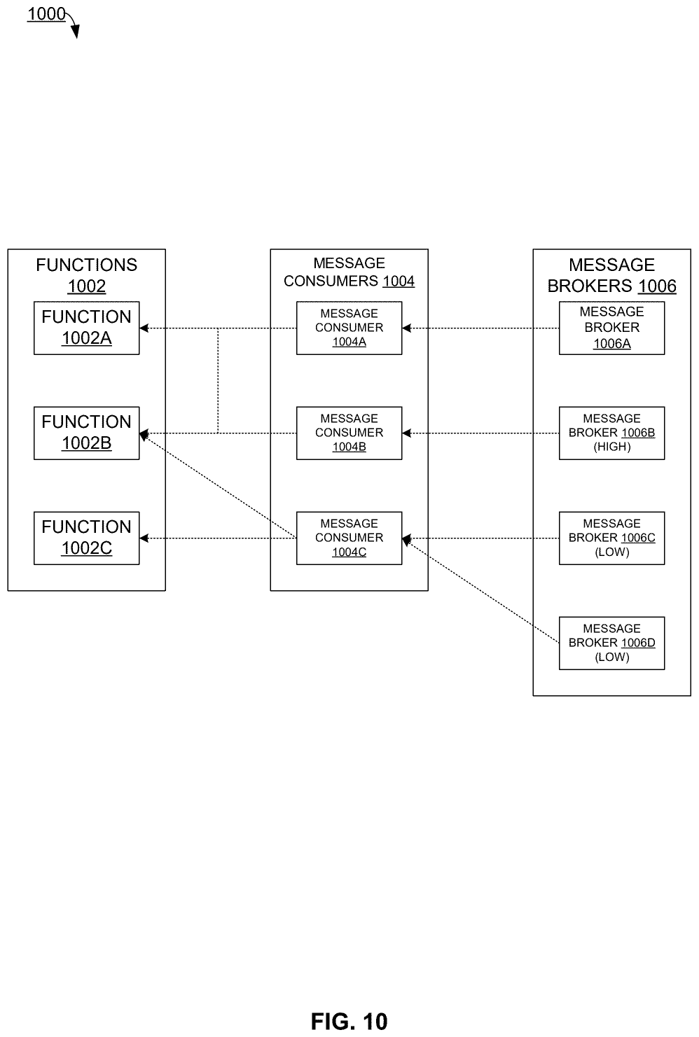

The examples of FIG. 9 and FIG. 10 can combine to show an unbalanced consumption example (FIG. 9) and remediating that unbalanced consumption example (FIG. 10). FIG. 11 can illustrate corresponding pseudocode to effectuate this.

Example 900 comprises function 902A, function 902B, function 902C, message consumer 904A, message consumer 904B, message consumer 904C, message broker 906A, message broker 906B, message broker 906C, and message broker 906D.

A consumer starvation example is as follows. In some cases, a system is neither overutilized nor underutilized. However, there can be a state where some message queues are more active than others. This state can lead to unbalanced consumption rates between message queues. In turn, the functions waiting for delivery can be “starved” and in such cases, this can result in application latency and/or bad user experience.

It can be that the following condition is to be met in order to choose a reallocation candidate: At least single queue with U unread message volume that is greater than MAX_U. MAX_U can be a predefined system parameter.

FIG. 10 illustrates another example 1000 of unbalanced consumption, and that can facilitate FaaS dynamic event propagation, in accordance with an embodiment of this disclosure. In some examples, part(s) of example 1000 can be implemented by part(s) of system architecture 100 of FIG. 1 to facilitate FaaS dynamic event propagation.

Example 1000 comprises function 1002A, function 1002B, function 1002C, message consumer 1004A, message consumer 1004B, message consumer 1004C, message broker 1006A, message broker 1006B, message broker 1006C, and message broker 1006D.

In this example, there are two message queues with “high” and “low” unread message volume attached to a single consumer.

In another consumer, a single message queue can be attached with “low” unread volume.

According to a reallocation strategy, the “low” message consumer can be reallocated to the second message consumer. This action can help the “high” message queue consume more messages and ideally reduce unread volume.

FIG. 11 illustrates example pseudocode 1100 for handling unbalanced consumption, and that can facilitate FaaS dynamic event propagation, in accordance with an embodiment of this disclosure. In some examples, part(s) of pseudocode 1100 can be implemented by part(s) of system architecture 100 of FIG. 1 to facilitate FaaS dynamic event propagation.

The following pseudocode can be implemented to choose between available consumers that do not have an unread volume exceeding a maximum as defined by the U_MAX parameter. Then the least unread volume consumer can be selected.

```
let cArr be an array of consumers excluding candidate consumer
let cAvailableArr be an array of consumers to hold reallocation candidates
foreach consumer in cArr
  hasMax = false
  foreach unreadVolume in consumer.queues
    if unreadVolume > U_MAX
      hasMax = true
  if not hasMax then
    add consumer to cAvailableArr
minU = MAX_INT
resultConsumer = nil
foreach consumer in cAvailableArr
  sumU = sum(consumer.queues.unreadVolumes)
  if minU > sumU then
    minU = sumU
    resultConsumer = consumer
return resultConsumer
```

### Example Process Flows

FIG. 12 illustrates an example process flow 1200 that can facilitate FaaS dynamic event propagation, in accordance with an embodiment of this disclosure. In some examples, one or more embodiments of process flow 1200 can be implemented by system architecture 100 of FIG. 1, or computing environment 1500 of FIG. 15.

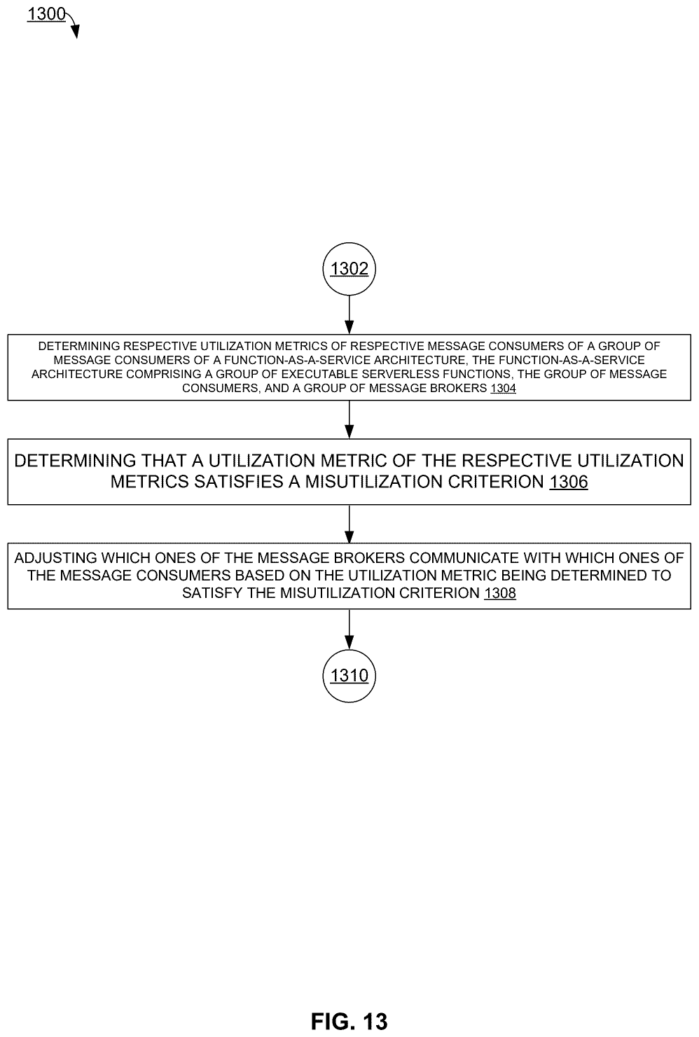

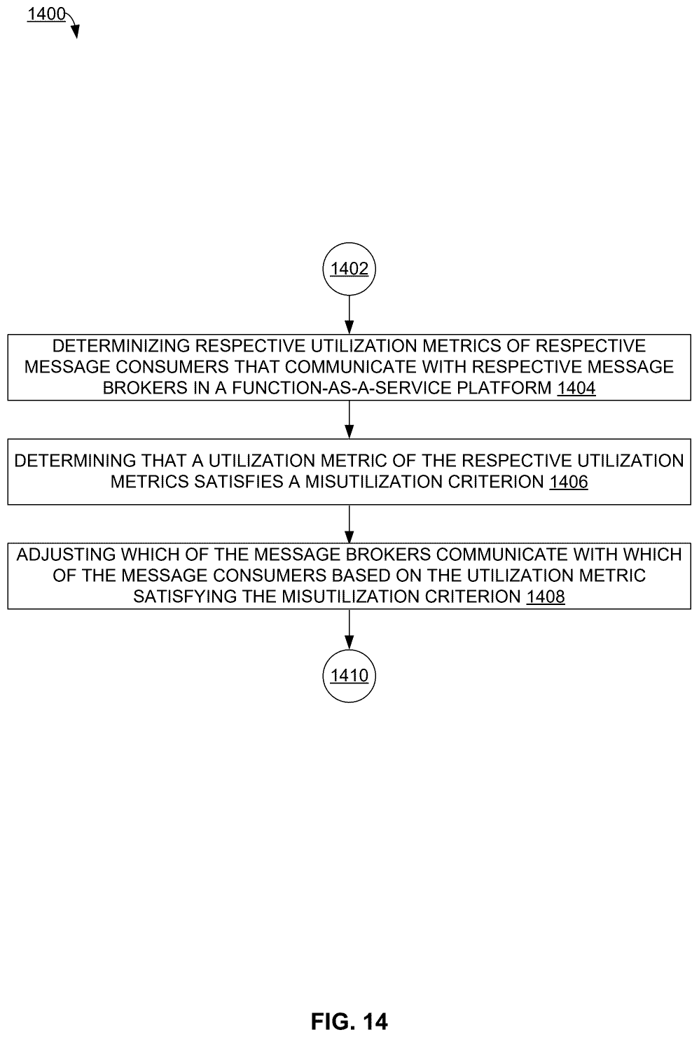

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of process flow 1300 of FIG. 13, and/or process flow 1400 of FIG. 14.

Process flow 1200 begins with 1202, and moves to operation 1204.

Operation 1204 depicts maintaining a function-as-a-service architecture that comprises a group of executable serverless functions, a group of message consumers, and a group of message brokers, wherein respective message brokers of the group of message brokers are configured to transmit respective messages to respective message consumers of the group of message consumers, and wherein the respective message consumers are configured to transmit the respective messages to respective functions of the group of executable serverless functions. Using the example of FIG. 1, there can be functions 110, message consumers 112, and message brokers 114.

After operation 1204, process flow 1200 moves to operation 1206.

Operation 1206 depicts determining respective utilization metrics of the respective message consumers. Using the example of FIG. 2, these utilization metrics can be the parameters collected by consumer allocation controller 210, such as:
1. The average CPU utilization percentage can be referred to as C.
2. The average memory utilization percentage can be referred to as M.
3. The average throughput (kilobytes/second (KB/sec) of a message queue can be referred to as TQ(i).
4. The average unread queue size of queue i can be referred to as U (i).

After operation 1206, process flow 1200 moves to operation 1208.

Operation 1208 depicts determining that a utilization metric of the respective utilization metrics satisfies a misutilization criterion. This misutilization criterion can include overutilization, underutilization, and/or starvation. For example, the misutilization criterion for overutilization can be:
1. Check if C is greater than MAX_C %. MAX_C can be a predefined system parameter.
2. Check if M is greater than MAX_M %. MAX_M can be a predefined system parameter.
3. There are at least two message queues attached to the consumer.

Configurable parameter T can be defined as the number of milliseconds used to determine the average parameters.

When (#1 OR #2) AND #3 of the above conditions are met, the number of message consumers can be increased, and one or more queues can be assigned to the new instance.

In some examples, the misutilization criterion comprises an overutilization criterion.

In some examples, the utilization metric indicates that a corresponding message consumer of the message consumers is connected to at least two message brokers of the group of message brokers, and the utilization metric indicates that a processor utilization level associated with the corresponding message consumer satisfies a maximum processor utilization criterion.

In some examples, the utilization metric indicates that a corresponding message consumer of the message consumers is connected to at least two message brokers of the group of message brokers, and the utilization metric indicates that a memory utilization level of the corresponding message consumer satisfies a maximum memory utilization criterion.

In some examples, the utilization metric indicates that a corresponding message consumer of the message consumers is connected to at least two message brokers of the group of message brokers, and the utilization metric indicates that either, a processor utilization level of the corresponding message consumer satisfies a maximum processor utilization criterion, or a memory utilization level of the corresponding message consumer satisfies a maximum memory utilization criterion.

That is, overutilization can occur where message consumer is connected to at least two message brokers and (C>C_MAX OR M>M_MAX).

After operation 1208, process flow 1200 moves to operation 1210.

Operation 1210 depicts adjusting which ones of the message brokers communicate with which ones of the message consumers based on the utilization metric being determined to satisfy the misutilization criterion. That is, depending on the misutilization criterion satisfied in operation 1208 (e.g., overutilization, underutilization, or starvation), a corresponding action can be taken. Continuing with the overutilization example, this can be similar to that which is depicted in FIG. 4.

In some examples, the utilization metric corresponds to a first message consumer of the message consumers, and the adjusting of which ones of the message brokers communicate with which ones of the message consumers comprises instantiating a second message consumer, and transferring at least one message broker that is connected to the first message consumer to be connected to the second message consumer. That is, overutilization can be addressed by spinning up another consumer and attaching at least one broker to it.

In some examples, the utilization metric corresponds to a first message consumer of the message consumers, and the adjusting of which ones of the message brokers communicate with which ones of the message consumers comprises transferring at least one message broker that is connected to the first message consumer to be connected to a second message consumer of the message consumers. That is, overutilization can be addressed by taking an existing consumer and connecting at least one broker to it.

In some examples, the utilization metric corresponds to a first message consumer of the message consumers, and the adjusting of which ones of the message brokers communicate with which ones of the message consumers comprises determining that a rebalancing criterion is satisfied with respect to the first message consumer, and with respect to a second message consumer, the adjusting comprises transferring at least one message broker that is connected to the first message consumer to be connected to the second message consumer. That is, a result of handling overutilization can be to balance out message brokers for message consumers.

After operation 1210, process flow 1200 moves to 1212, where process flow 1200 ends.

FIG. 13 illustrates an example process flow 1300 that can facilitate FaaS dynamic event propagation, in accordance with an embodiment of this disclosure. In some examples, one or more embodiments of process flow 1300 can be implemented by system architecture 100 of FIG. 1, or computing environment 1500 of FIG. 15.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of process flow 1200 of FIG. 12, and/or process flow 1400 of FIG. 14.

Process flow 1300 begins with 1302, and moves to operation 1304.

Operation 1304 depicts determining respective utilization metrics of respective message consumers of a group of message consumers of a function-as-a-service architecture, the function-as-a-service architecture comprising a group of executable serverless functions, the group of message consumers, and a group of message brokers. In some examples, operation 1304 can be implemented in a similar manner as operations 1204-1206 of FIG. 12.

After operation 1304, process flow 1300 moves to operation 1306.

Operation 1306 depicts determining that a utilization metric of the respective utilization metrics satisfies a misutilization criterion. In some examples, operation 1306 can be implemented in a similar manner as operation 1208 of FIG. 12.

In some examples, the utilization metric indicates that a first message consumer of the message consumers has a first processor utilization level that satisfies a minimum processor utilization criterion, and the utilization metric indicates that a second message consumer of the message consumers has a second processor utilization level that satisfies the minimum processor utilization criterion.

In some examples, the utilization metric indicates that a first message consumer of the message consumers has a first memory utilization level that satisfies a minimum memory utilization criterion, and the utilization metric indicates that a second message consumer of the message consumers has a second memory utilization level that satisfies the minimum memory utilization criterion.

In some examples, the utilization metric indicates that a first length of a first unread message queue of a first message consumer of the message consumers satisfies a maximum queue length criterion, and the utilization metric indicates that a second length of a second unread message queue of a second message consumer of the message consumers satisfies the maximum queue length criterion.

In some examples, the utilization metric indicates that a first message consumer of the message consumers has a first processor utilization level that satisfies a minimum processor utilization criterion, the utilization metric indicates that a second message consumer of the message consumers has a second processor utilization level that satisfies the minimum processor utilization criterion, the utilization metric indicates that the first message consumer has a first memory utilization level that satisfies a minimum memory utilization criterion, the utilization metric indicates that the second message consumer has a second memory utilization level that satisfies the minimum memory utilization criterion, the utilization metric indicates that a first length of a first unread message queue of the first message consumer that satisfies a maximum queue length criterion, and the utilization metric indicates that a second length of a second unread message queue of the second message consumer that satisfies the maximum queue length criterion.

That is, underutilization can occur where there are consumers with C<C_MIN; there are two consumers with M<M_MIN; there are two consumers with U<U_MAX; and/or there are two consumers with C<C_MIN, M_MIN, AND U<U_MAX.

After operation 1306, process flow 1300 moves to operation 1308.

Operation 1308 depicts adjusting which ones of the message brokers communicate with which ones of the message consumers based on the utilization metric being determined to satisfy the misutilization criterion. In some examples, operation 1308 can be implemented in a similar manner as operation 1210 of FIG. 12.

In some examples, the misutilization criterion comprises an underutilization criterion.

In some examples, the utilization metric corresponds to a first message consumer of the message consumers and a second message consumer of the message consumers, and the adjusting of which ones of the message brokers communicate with which ones of the message consumers comprises transferring at least one message broker that is connected to the first message consumer to be connected to the second message consumer of the message consumers, wherein, after the transferring, the second message consumer has a processor utilization level that satisfies a maximum processor utilization criterion, the second message consumer has a has a memory utilization level that satisfies a maximum memory utilization criterion, and a length of an unread message queue of the second message consumer that satisfies a maximum queue length criterion; and after the transferring, terminating execution of the first message consumer.

That is, a result of handling underutilization can be combining two of the queues for two message consumers, and this message consumer is not overloaded as a result.

After operation 1308, process flow 1300 moves to 1310, where process flow 1300 ends.

FIG. 14 illustrates an example process flow 1400 that can facilitate FaaS dynamic event propagation, in accordance with an embodiment of this disclosure. In some examples, one or more embodiments of process flow 1400 can be implemented by system architecture 100 of FIG. 1, or computing environment 1500 of FIG. 15.

It can be appreciated that the operating procedures of process flow 1400 are example operating procedures, and that there can be embodiments that implement more or fewer operating procedures than are depicted, or that implement the depicted operating procedures in a different order than as depicted. In some examples, process flow 1400 can be implemented in conjunction with one or more embodiments of process flow 1200 of FIG. 12, and/or process flow 1300 of FIG. 13.

Process flow 1400 begins with 1402, and moves to operation 1404.

Operation 1404 depicts determinizing respective utilization metrics of respective message consumers that communicate with respective message brokers in a function-as-a-service platform. In some examples, operation 1404 can be implemented in a similar manner as operations 1204-1206 of FIG. 12.

After operation 1404, process flow 1400 moves to operation 1406.

Operation 1406 depicts determining that a utilization metric of the respective utilization metrics satisfies a misutilization criterion. In some examples, operation 1406 can be implemented in a similar manner as operation 1208 of FIG. 12.

In some examples, the misutilization criterion comprises a starvation criterion, the starvation criterion differs from an underutilization criterion, and the starvation criterion differs from an overutilization criterion.

In some examples, the utilization metric indicates that a corresponding message consumer of the message consumers is connected to at least two message brokers of the message brokers, and the utilization metric indicates that a length of an unread message queue of a first message consumer of the message consumers satisfies a maximum queue length criterion.

That is, starvation can occur where there are multiple message brokers for a consumer, and the consumer's unread queue length >U_MAX.

In some examples, the determining of the respective utilization metrics of the respective message consumers is performed during a time window. That is, there can be a configurable parameter T that represents a length of time used to determine the utilization metrics.

After operation 1406, process flow 1400 moves to operation 1408.

Operation 1408 depicts adjusting which of the message brokers communicate with which of the message consumers based on the utilization metric satisfying the misutilization criterion. In some examples, operation 1408 can be implemented in a similar manner as operation 1210 of FIG. 12.

In some examples, the utilization metric indicates that a corresponding first message consumer of the message consumers is connected to a first message broker of the message brokers, the utilization metric indicates that the first message consumer is connected to a second message broker of the message brokers, the first message broker corresponds to a first number of unread messages, the second message broker corresponds to a second number of unread messages, and the adjusting of which of the message brokers communicate with which of the message consumers comprises, based on the second number of unread messages being less than the first number of unread messages, transferring the second message broker from being connected to the first message consumer to being connected to a second message consumer of the message consumers. That is, starvation can be handled by transferring a broker with a lower unread message count to another consumer.

After operation 1408, process flow 1400 moves 1410, where process flow 1400 ends.

### Example Operating Environment

In order to provide additional context for various embodiments described herein, FIG. 15 and the following discussion are intended to provide a brief, general description of a suitable computing environment 1500 in which the various embodiments of the embodiment described herein can be implemented.

For example, parts of computing environment 1500 can be used to implement one or more embodiments of computer system 102 and/or user computer 106 of FIG. 1.

In some examples, computing environment 1500 can implement one or more embodiments of the process flows of FIGS. 12-14 to facilitate FaaS dynamic event propagation.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 15, the example environment 1500 for implementing various embodiments described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a nonvolatile storage such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), one or more external storage devices 1516 (e.g., a magnetic floppy disk drive (FDD) 1516, a memory stick or flash drive reader, a memory card reader, etc.) and an optical disk drive 1520 (e.g., which can read or write from a CD-ROM disc, a DVD, a BD, etc.). While the internal HDD 1514 is illustrated as located within the computer 1502, the internal HDD 1514 can also be configured for external use in a suitable chassis (not shown). Additionally, while not shown in environment 1500, a solid state drive (SSD) could be used in addition to, or in place of, an HDD 1514. The HDD 1514, external storage device(s) 1516 and optical disk drive 1520 can be connected to the system bus 1508 by an HDD interface 1524, an external storage interface 1526 and an optical drive interface 1528, respectively. The interface 1524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application.

Further, computer 1502 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can be also connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer(s) 1550. The remote computer(s) 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. It will be appreciated that the network connections shown are examples, and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1516 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
maintaining a function-as-a-service architecture that comprises a group of executable serverless functions, a group of message consumers, and a group of message brokers, wherein respective message brokers of the group of message brokers are configured to transmit respective messages to respective message consumers of the group of message consumers, and wherein the respective message consumers are configured to transmit the respective messages to respective functions of the group of executable serverless functions;
determining respective utilization metrics of the respective message consumers;
determining that a utilization metric of the respective utilization metrics satisfies a misutilization criterion; and
adjusting which ones of the message brokers communicate with which ones of the message consumers based on the utilization metric being determined to satisfy the misutilization criterion.

2. The system of claim 1, wherein the misutilization criterion comprises an overutilization criterion.

3. The system of claim 2, wherein the utilization metric indicates that a corresponding message consumer of the message consumers is connected to at least two message brokers of the group of message brokers, and wherein the utilization metric indicates that a processor utilization level associated with the corresponding message consumer satisfies a maximum processor utilization criterion.

4. The system of claim 2, wherein the utilization metric indicates that a corresponding message consumer of the message consumers is connected to at least two message brokers of the group of message brokers, and wherein the utilization metric indicates that a memory utilization level of the corresponding message consumer satisfies a maximum memory utilization criterion.

5. The system of claim 2, wherein the utilization metric indicates that a corresponding message consumer of the message consumers is connected to at least two message brokers of the group of message brokers, and wherein the utilization metric indicates that either,
a processor utilization level of the corresponding message consumer satisfies a maximum processor utilization criterion, or
a memory utilization level of the corresponding message consumer satisfies a maximum memory utilization criterion.

6. The system of claim 2, wherein the utilization metric corresponds to a first message consumer of the message consumers, and wherein the adjusting of which ones of the message brokers communicate with which ones of the message consumers comprises:
instantiating a second message consumer; and
transferring at least one message broker that is connected to the first message consumer to be connected to the second message consumer.

7. The system of claim 2, wherein the utilization metric corresponds to a first message consumer of the message consumers, and wherein the adjusting of which ones of the message brokers communicate with which ones of the message consumers comprises:
transferring at least one message broker that is connected to the first message consumer to be connected to a second message consumer of the message consumers.

8. The system of claim 2, wherein the utilization metric corresponds to a first message consumer of the message consumers, and wherein the adjusting of which ones of the message brokers communicate with which ones of the message consumers comprises:
determining that a rebalancing criterion is satisfied with respect to the first message consumer, and with respect to a second message consumer, wherein the adjusting comprises transferring at least one message broker that is connected to the first message consumer to be connected to the second message consumer.

9. A method, comprising:
determining, by a system comprising at least one processor, respective utilization metrics of respective message consumers of a group of message consumers of a function-as-a-service architecture, the function-as-a-service architecture comprising a group of executable serverless functions, the group of message consumers, and a group of message brokers;
determining, by the system, that a utilization metric of the respective utilization metrics satisfies a misutilization criterion; and
adjusting, by the system, which ones of the message brokers communicate with which ones of the message consumers based on the utilization metric being determined to satisfy the misutilization criterion.

10. The method of claim 9, wherein the misutilization criterion comprises an underutilization criterion.

11. The method of claim 9, wherein the utilization metric indicates that a first message consumer of the message consumers has a first processor utilization level that satisfies a minimum processor utilization criterion, and wherein the utilization metric indicates that a second message consumer of the message consumers has a second processor utilization level that satisfies the minimum processor utilization criterion.

12. The method of claim 9, wherein the utilization metric indicates that a first message consumer of the message consumers has a first memory utilization level that satisfies a minimum memory utilization criterion, and wherein the utilization metric indicates that a second message consumer of the message consumers has a second memory utilization level that satisfies the minimum memory utilization criterion.

13. The method of claim 9, wherein the utilization metric indicates that a first length of a first unread message queue of a first message consumer of the message consumers satisfies a maximum queue length criterion, and wherein the utilization metric indicates that a second length of a second unread message queue of a second message consumer of the message consumers satisfies the maximum queue length criterion.

14. The method of claim 9, wherein the utilization metric indicates that a first message consumer of the message consumers has a first processor utilization level that satisfies a minimum processor utilization criterion,
wherein the utilization metric indicates that a second message consumer of the message consumers has a second processor utilization level that satisfies the minimum processor utilization criterion,
wherein the utilization metric indicates that the first message consumer has a first memory utilization level that satisfies a minimum memory utilization criterion,
wherein the utilization metric indicates that the second message consumer has a second memory utilization level that satisfies the minimum memory utilization criterion,
wherein the utilization metric indicates that a first length of a first unread message queue of the first message consumer that satisfies a maximum queue length criterion, and
wherein the utilization metric indicates that a second length of a second unread message queue of the second message consumer that satisfies the maximum queue length criterion.

15. The method of claim 9, wherein the utilization metric corresponds to a first message consumer of the message consumers and a second message consumer of the message consumers, and wherein the adjusting of which ones of the message brokers communicate with which ones of the message consumers comprises:
transferring at least one message broker that is connected to the first message consumer to be connected to the second message consumer of the message consumers, wherein, after the transferring,
the second message consumer has a processor utilization level that satisfies a maximum processor utilization criterion,
the second message consumer has a memory utilization level that satisfies a maximum memory utilization criterion, and
a length of an unread message queue of the second message consumer that satisfies a maximum queue length criterion; and
after the transferring, terminating execution of the first message consumer.

16. A non-transitory computer-readable medium comprising instructions that, in response to execution, cause a system comprising at least one processor to perform operations, comprising:
determinizing respective utilization metrics of respective message consumers that communicate with respective message brokers in a function-as-a-service platform;
determining that a utilization metric of the respective utilization metrics satisfies a misutilization criterion; and
adjusting which of the message brokers communicate with which of the message consumers based on the utilization metric satisfying the misutilization criterion.

17. The non-transitory computer-readable medium of claim 16, wherein the misutilization criterion comprises a starvation criterion, wherein the starvation criterion differs from an underutilization criterion, and wherein the starvation criterion differs from an overutilization criterion.

18. The non-transitory computer-readable medium of claim 17, wherein the utilization metric indicates that a corresponding message consumer of the message consumers is connected to at least two message brokers of the message brokers, and wherein the utilization metric indicates that a length of an unread message queue of a first message consumer of the message consumers satisfies a maximum queue length criterion.

19. The non-transitory computer-readable medium of claim 17, wherein the utilization metric indicates that a corresponding first message consumer of the message consumers is connected to a first message broker of the message brokers, wherein the utilization metric indicates that the first message consumer is connected to a second message broker of the message brokers, wherein the first message broker corresponds to a first number of unread messages, wherein the second message broker corresponds to a second number of unread messages, and wherein the adjusting of which of the message brokers communicate with which of the message consumers comprises:
based on the second number of unread messages being less than the first number of unread messages, transferring the second message broker from being connected to the first message consumer to being connected to a second message consumer of the message consumers.

20. The non-transitory computer-readable medium of claim 16, wherein the determining of the respective utilization metrics of the respective message consumers is performed during a time window.
